(19) United States
(12) Patent Application Publication
(10) Pub. No.: US 2015/0202844 A1
(43) Pub. Date: Jul. 23, 2015

(54) SANDWICH SHEET AND PROCESS FOR PRODUCTION THEREOF

(71) Applicant: THYSSENKRUPP STEEL EUROPE AG, Duisburg (DE)

(72) Inventors: Thorsten Böger, Duisburg (DE); Peter Klauke, Schwerte (DE); Tobias Lewe, Münster (DE)

(73) Assignee: THYSSENKRUPP STEEL EUROPE AG, Duisburg (DE)

(21) Appl. No.: 14/414,013

(22) PCT Filed: Jun. 18, 2013
(86) PCT No.: PCT/EP2013/062635

§ 371 Date: Jan. 9, 2015

(30) Foreign Application Priority Data
Jul. 10, 2012 (DE) 10 2012 106 206.4

(51) Int. Cl. B32B 15/14; B32B 37/06; B32B 37/18; B32B 37/10; B32B 15/18; B32B 15/20

(52) U.S. Cl. CPC B32B 15/14; B32B 15/18; B32B 15/20; B32B 37/182; B32B 37/10; B32B 37/06; B32B 2260/046; B32B 2262/105; B32B 2250/03; B32B 2255/06; B32B 2255/205; B32B 2305/38; B32B 2305/188; B32B 2305/076; B32B 2305/20; B32B 2419/00; B32B 2605/00

(57) ABSTRACT

The invention relates to a sandwich sheet, in particular for the production of construction components or of vehicle body parts, with metallic cover sheets and with, arranged between the cover sheets, at least one core layer made of polymer and is integrally joined to the cover sheets. The core layer of the sandwich sheet comprises according to the invention a fibre-containing carrier, the fibres of the carrier are surrounded by a polyurethane matrix, in which the polyurethane matrix has been formed from an aqueous, solvent-free polyurethane dispersion, in which the fibres have the form of relatively short fibre pieces with a total fibre length of maximum 50 mm in the polyurethane matrix. The fibres of the carrier are preferably composed of mineral fibres, in particular of ceramic fibres. The sandwich sheet of the invention features an inexpensive, lightweight core layer which extends the range of possible uses of the sandwich sheet. A process is moreover disclosed for the production of this sandwich sheet.

The invention relates to a sandwich sheet, in particular for producing construction components or vehicle body parts, with metallic cover sheets and with, arranged between the cover sheets, at least one core layer made of polymer and is integrally joined to the cover sheets. In particular, the invention relates to a process for producing a sandwich sheet, in particular for use in the construction industry or vehicle bodywork construction, by integrally joining, with use of pressure and heat, of metallic cover sheets to a core layer arranged there between made of polymer.

Sandwich material of this type is known.

A sandwich sheet developed by the applicant and known as “LITECOR” is composed of two cover sheets made of steel and of a core layer made of plastic. This sandwich sheet features relatively low weight with good bending stiffness for applications inter alia in vehicle bodywork construction. The core layer of this material is composed of a thermoplastic copolymer.

The present invention was based on the object of further developing a sandwich sheet of the abovementioned type in such a way that it has an inexpensive core layer with a higher level of stiffness properties, and in particular is cold-formable, while its range of possible uses suffers no restriction. The intention is, instead, to extend the range of possible uses of this type of sandwich sheet.

The said object is achieved by proposing a sandwich sheet with the features of Claim 1 and a producing process with the features of Claim 9.

The core layer of the sandwich sheet of the invention comprises a fibre-containing carrier, the fibres of the carrier are surrounded by a polyurethane matrix, in which the latter has been formed from an aqueous, solvent-free polyurethane dispersion, in which the fibres have the form of relatively short fibre pieces with a total length of maximum 50 mm in the polyurethane matrix.

By virtue of the fibre-containing carrier, a base is provided which, in combination with the polyurethane matrix surrounding the fibres, represents an inexpensive and lightweight core layer for the sandwich sheet. By virtue of the short fibre pieces surrounded or pre-impregnated by the polyurethane matrix, the sandwich sheet is amenable to cold forming with particularly good results.

Various inexpensive types of fibre can be used as fibres for the core layer of the sandwich sheet of the invention. The fibres can be used to influence the properties of the sandwich sheet and therefore to extend its range of possible uses.

According to one advantageous embodiment of the sandwich sheet of the invention, the fibres of the core layer are composed of mineral fibres, preferably of ceramic fibres. It is thus possible to achieve a lightweight, heat-resistant sandwich sheet with good to very good bending stiffness.

Another advantageous embodiment of the invention is characterized in that the polyurethane dispersion comprises blocked isocyanate or blocked isocyanate is added to the aqueous, solvent-free polyurethane dispersion for producing the core layer. Heat-resistant fibres, such as ceramic fibres and glass fibres, can be brittle and allow only a small degree of forming. In order in particular to increase the elasticity and the bond strength of the fibre-containing carrier impregnated with aqueous, solvent-free PU dispersion for use as core layer of the sandwich sheet of the invention, blocked NCO (isocyanate) is added to the PU dispersion. The term “blocked” means that the NCO content in the PU dispersion is insulated at room temperature (about 20° C.) and is activated only when a certain temperature is reached. This allows inter alia greater crosslinking of the polyurethane dispersion. Preferably aromatic isocyanates (e.g. monomeric diphenylmethane diisocyanates) and/or aliphatic isocyanates (e.g. isophorone diisocyanate) as blocked NCO is added.

In another embodiment of the invention, the fibre-containing carrier for the core layer of the sandwich sheet has the form of laid scrim, woven fabric, knitted fabric or non-woven fabric. It is possible to influence the bending stiffness and the forming capability of the sandwich sheet of the invention via the structure of the fibre-containing carrier. To achieve particularly high bending stiffness it is preferable that the fibre-containing carrier has the form of woven fabric. In contrast, good to very good forming capability can be achieved more successfully with a fibre layer that has the form of non-woven fabric.

It is preferable that the thickness of the core layer of the sandwich sheet of the invention is in the range from 0.4 mm to 2.0 mm, particularly being at most 1.5 mm

Suitable cover sheets for the sandwich sheet of the invention are sheets made of aluminum material, magnesium material or steel material and combinations of these. It is particularly preferable to use cover sheets made of steel material, in which the thickness of these is in the range from 0.1 mm to 1.0 mm, preferably in the range from 0.2 mm to 0.8 mm. Steel material is a relatively inexpensive material which features high resistance to temperature change, high breaking strength and good formability, in particular advantageous deep-drawing properties and/or embossing properties. The steel outer sheets used here typically have yield points in the range from 250 to 350 MPa. It is also possible to use other stiffness levels with higher yield strength.

Another embodiment of the invention provides that the cover sheets have a corrosion-protection layer in order to achieve low materials costs and at the same time high lifetime of the construction component of the invention. The corrosion-protection layer is by way of example realized via hot-dip coating and/or electrolytic coating of the metallic cover sheets. Typical hot-dip coatings are: Z: 99% Zn, ZA: 95% Zn+5% Al; AZ: 5% Al+43.4% Zn+1.6% Si; AS: 88-92% Al+8-12% Si.

Another advantageous embodiment of the sandwich sheet of the invention is characterized in that the cover sheets have different thickness and/or have different corrosion-protection layers. It is thus possible to achieve a sandwich sheet optimized in respect of high bending stiffness, low component weight and high corrosion resistance.

In another embodiment of the sandwich sheet of the invention, at least one of the cover sheets has a corrosion-protection layer composed of zinc. Alternatively or in addition, at least one of the cover sheets can also have a corrosion-protection layer composed of aluminum.

Other possibilities that can likewise be used alongside traditional hot-dip coating and electrolytic coating are CVD coatings, PVD coatings and/or sol-gel coatings. The cover sheets can moreover also be, or have been, subjected to further finishing, for example by means of an anodizing process. Any desired coloring can thus be achieved.

According to another embodiment of the sandwich sheet of the invention, at least one of the cover sheets has an organic layer, for example in the form of lacquer or of a lacquered foil or lacquer film Any desired coloring of the sandwich sheet of the invention can thus be achieved. It is preferable that the organic layer has a luminous property (luminous character).

One advantageous embodiment of the process of the invention is characterized in that before the core layer is joined to the cover sheets it is penetrated and/or mechanically dewatered. The water content of the fibre-containing carrier is thus effectively reduced after it has been impregnated by the aqueous, solvent-free polyurethane dispersion. It is thus possible to achieve reliable prevention of internal corrosion at the metallic cover sheets. The reduction of water content can by way of example be achieved when the core layer is built up from a plurality of fibre-containing carriers (fibre layers) via layer-by-layer application of the aqueous, solvent-free PU dispersion, preferably with addition of blocked NCO, in which the PU dispersion is by way of example forced into the respective fibre layer by means of at least one spiked roll, rubber-covered roll or the like, and/or excess water can be removed by compression. In contrast, when only one fibre layer is used, the reduction of water content can by way of example be achieved by increasing the porosity of the fibre layer.

Another preferred embodiment of the process of the invention provides that the sandwich sheet produced from the cover sheets and from the core layer is cooled immediately after the integrally joining of core layer and cover sheets, and during the cooling is simultaneously pressed or rolled. It is thus possible to assist the volume shrinkage or compaction of the core layer that is associated with the removal of water. In particular, it is thus possible to achieve controlled reduction of stresses in the composite (sandwich sheet).

The invention is illustrated below with reference to a drawing providing diagrams of a number of embodiments:

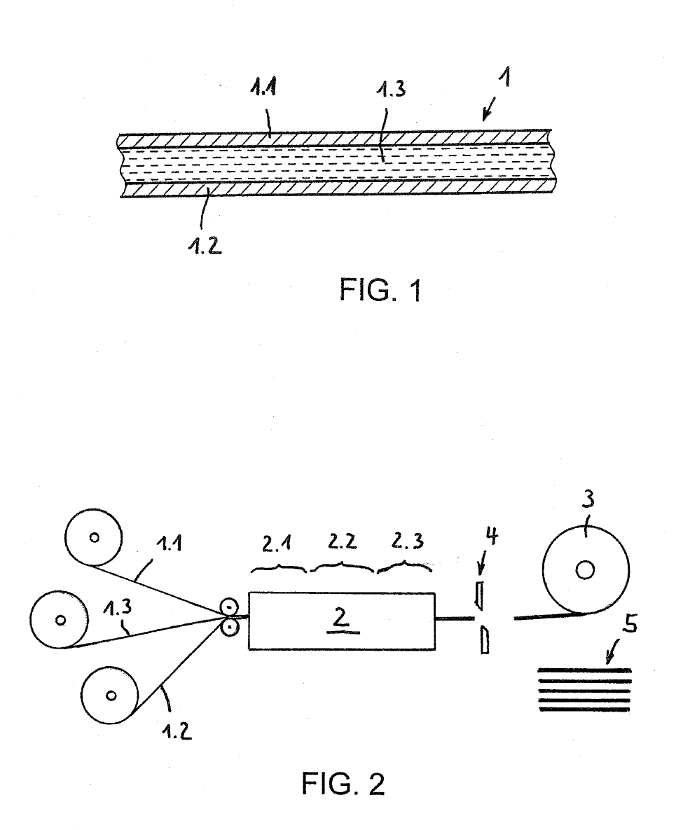

FIG. 1 a sectional view of part of a sandwich sheet of the invention; and

FIG. 2 a system for producing of a sandwich sheet of the invention.

The sandwich sheet 1 shown in the drawing is composed of two metallic cover layers 1.1, 1.2 and of a fibre-containing, heat-resistant core layer 1.3.

The cover layers 1.1, 1.2 are preferably composed of steel sheet which has a corrosion-protection layer. It is preferable here to use zinc- or aluminum-based corrosion-protection layers. The thickness of each cover layer (cover sheet) 1.1, 1.2 is by way of example about 0.1 to 0.8 mm, preferably at most 0.5 mm, particularly preferably at most 0.4 mm. In the embodiment shown in FIG. 1, the thickness of the two cover sheets 1.1, 1.2 is in essence the same, e.g. about 0.3 mm, and they comprise the same type of material. However, it is also possible to produce the composite 1 by using cover sheets 1.1, 1.2 of different thickness and/or comprising different types of material. In particular, the cover sheets 1.1, 1.2 can have different corrosion-protection layers: by way of example, the cover sheet 1.1 or 1.2 can have an aluminum-based coating having high heat reflectance, while the other cover sheet 1.2 or 1.1 has a zinc-based coating.

The core layer 1.3 is composed of at least one fibre layer or one fibre-containing carrier and the fibres of the carrier are surrounded by a polyurethane matrix. The matrix is produced via infiltration/impregnation of the fibre-containing carrier with an aqueous, solvent-free polyurethane dispersion. The term “prepreg” in the present context means pre-impregnated fibres, in which the fibres in the polyurethane matrix have the form of continuous-filament fibres or else of relatively short fibre pieces, for example with a total fibre length of maximum 50 mm. The PU dispersion or the PU matrix acts as binder (adhesive).

It is preferable that the polyurethane dispersion also comprises a blocked NCO (isocyanate) which is passive at room temperature and is activated only on heating to a certain temperature, for example 50° C. Aromatic and aliphatic isocyanates are suitable for this type of blocking agent, examples being monomeric diphenylmethane diisocyanates and isophorone diisocyanate. Use of an appropriate blocking agent can achieve greater crosslinking of the polyurethane dispersion. The mixing ratio of PU dispersion and blocked NCO depends on the activation temperature, and also on the desired degree of crosslinking within the fibre-containing carrier.

The fibres of the carrier are composed of mineral fibres resistant to high temperature, preferably of incombustible ceramic fibres. The fibre-containing carrier here has the form of laid scrim, woven fabric or non-woven fabric. The fibre-containing carrier used for the production of the core layer 1.3 is porous in the sense of open-pored, i.e. permeable to liquid.

Producing the sandwich sheet 1 of the invention uses the core layer 1.3 in the form of prefabricated semi-finished product, for example in the form of what is known as a prepreg. The term “prepreg” in the present context means pre-impregnated fibres, in which the fibres in the polyurethane matrix have the form of continuous-filament fibres or else of relatively short fibre pieces, for example with a total fibre length of maximum 50 mm.

The thickness of the core layer 1.3 of the sandwich sheet 1 of the invention is in the range from 0.4 mm to 2.0 mm, preferably at most 1.5 mm. This layer resists temperatures of at least 300° C., preferably at least 700° C. The core layer 1.3 can moreover comprise a halogen-free mineral flame retardant which is highly effective in reducing smoke generation.

The fibre-containing core layer 1.3 provides, to the sandwich sheet 1 of the invention, not only high resistance to temperature change together with good thermal insulation but also a markedly higher level of stiffness properties in comparison with a conventional core layer made of thermoplastic. This higher level of stiffness properties allows use of relatively thin metallic cover layers 1.1, 1.2, and therefore reduction of the weight of the sandwich sheet 1 is possible.

It can be seen in FIG. 1 that each of the cover sheets 1.1, 1.2 of the composite 1 is markedly thinner than the core layer 1.3. To achieve a lightweight sandwich sheet the thickness of the core layer 1.3 is at least 1.5 times, preferably at least 2 times, and particularly preferably at least 2.5 times, the thickness of the thinnest of the two cover sheets 1.1, 1.2.

FIG. 2 is a diagram of a process for the production of a sandwich material 1 of the invention. It is preferable that the cover sheets 1.1, 1.2 and the prefabricated core layer 1.3 are provided in the form of coils and are unwound from the coil. Alternatively it is also possible to provide the components 1.1, 1.2 and 1.3 in the form of cut-to-size blanks (panels), and to join these to one another.

The cover sheets 1.1, 1.2 and the prefabricated core layer 1.3 are introduced into a heated press 2, preferably a twin-belt press. The composite is heated in the press 2 to about 120° C. to 180° C., preferably at most 160° C. The pressure generated by the press, in particular twin-belt press 2, can be in essence constant. The pressure applied can by way of example be up to at most 30 bar. However, the press 2 can also advantageously operate with different pressures: by way of example in a twin-belt press 2 divided into a heating zone 2.1, a temperature keeping zone 2.2 and a cooling zone 2.3, the pressure in the temperature keeping zone 2.2 can be markedly higher than in the following cooling zone (cooling stage).

As already mentioned above, the PU matrix acts as binder (adhesive), in particular when blocked NCO (isocyanate) has been added to the aqueous, solvent-free PU dispersion with which the fibre layer(s) has/have been impregnated. Heating of the composite made of the cover sheets 1.1, 1.2 and of the prefabricated core layer 1.3 activates and/or reactivates the adhesive function of the PU matrix. The core layer 1.3 prefabricated according to the invention requires no additional adhesion-promoter layer for the integrally joining to the cover sheets 1.1, 1.2, in particular requires no organic adhesion-promoter layer.

The pressure prevailing in the cooling zone 2.3, in which the composite is preferably cooled down to room temperature, is advantageously moderate, thus assisting, or being capable of assisting, compaction (volume shrinkage) of the core layer due to removal of water from the PU matrix. This procedure provides controlled reduction of stresses usually present in the composite.

Downstream of the twin-belt press 2, the sandwich sheet 1 produced is wound up to a coil 3 or cut to length by means of a cutting device 4 to individual panels 5.

The sandwich sheet 1 of the invention gives good results in plastic-forming processes, in particular via deep-drawing and/or embossing. For this by way of example blanks are cut out from an appropriate composite 1 in the form of a strip and are cold-formed in a forming press (not shown) to achieve three-dimensional components, e.g. vehicle body parts. Because the fibre length in the polyurethane matrix is short, the components here, in particular vehicle body parts, can be produced with almost any desired shapes or profiles, and with various dimensions.

The sandwich sheet 1 of the invention can also be used advantageously by way of example in shipbuilding, aircraft construction, rail vehicle construction, plant engineering, and also furniture construction.

The invention is not restricted to the embodiments shown in the drawing. There are numerous conceivable variants of the sandwich sheet of the invention and, respectively, of the process for production thereof which also make use of the invention set out in the attached claims in embodiments that differ from the embodiments shown. By way of example the cover sheets 1.1, 1.2 can also be composed of aluminum material and/or magnesium material.

1.-16. (canceled)

17. A sandwich sheet for use in the production of construction components or vehicle body parts, comprising:
a first metallic cover sheet;
a second metallic cover sheet spaced apart from said first metallic cover sheet; and
at least one polymer core layer integrally disposed between and affixed to each of said first and second metallic cover sheets, said core layer including at least,
a fibre-containing carrier having a plurality of incombustible ceramic fibres integrally disposed therein that each have a maximum length of 50 mm, and
a polyurethane matrix surrounding said fibres of said fibre-containing carrier, which polyurethane matrix is formed from an aqueous, solvent-free polyurethane dispersion.

18. The sandwich sheet of claim 17, wherein the polyurethane dispersion comprises blocked isocyanate.

19. The sandwich sheet of claim 17, wherein the fibre-containing carrier is at least one of laid scrim, woven fabric, or non-woven fabric.

20. The sandwich sheet of claim 17, wherein said core layer has a thickness between about 0.4 mm to about 2.0 mm

21. The sandwich sheet of claim 17, wherein said first and second metallic cover sheets are made from at least one of aluminium, magnesium, steel.

22. The sandwich sheet of claim 17, wherein each of said first and second cover sheets has a thickness between about 0.1 mm to about 1.0 mm.

23. The sandwich sheet of claim 17, wherein at least one of said first or second cover sheets has a corrosion-protection layer disposed thereon.

24. A method for producing a sandwich sheet for use in the construction industry or in the manufacturing of vehicle bodywork, comprising:
by the use of pressure and heat, integrally joining a first metallic cover sheet to a first side of a polymer core layer, the polymer core layer including at least,
a fibre-containing carrier having a plurality of incombustible ceramic fibres integrally disposed therein that each have a maximum length of 50 mm, and
a polyurethane matrix surrounding said fibres of said fibre-containing carrier, which polyurethane matrix is formed from an aqueous, solvent-free polyurethane dispersion; and
by the use of pressure and heat, integrally joining a second metallic cover sheet to a second side of the core layer that is opposite to the first side of the core layer.

25. The method of claim 24, wherein the polyurethane dispersion further includes blocked isocyanate.

26. The method of claim 25, wherein the blocked isocyanate includes at least one of aromatic or aliphatic isocyanates.

27. The method of claim 24, further comprising at least one of penetrating the core layer or mechanically dewatering the core layer, prior to said steps of integrally joining the first and second metallic cover sheets to the core layer.

28. The method of claim 24, wherein the first and second metallic cover sheets are made from at least one of aluminium, magnesium, steel.

29. The method of claim 24, wherein said first and second metallic cover sheets are made of steel and have a corrosion-protection layer disposed thereon.

30. The method of claim 24, further comprising:
cooling the integrally joined core layer and cover sheets immediately after the steps of integrally joining the first and second metallic cover sheets to the core layer; and
during said cooling step, at least one of simultaneously pressing or rolling said integrally joined core layer and cover sheets.
